(19) United States
(12) Patent Application Publication
(10) Pub. No.: US 2005/0184226 A1
(43) Pub. Date: Aug. 25, 2005

(54) Sensor arrangement

(75) Inventors: Carsten Heilenkotter, Weyhe (DE); Thomas Niemann, Delmenhorst (DE)

Correspondence Address: WILLIAM COLLARD;COLLARD & ROE, P.C., 1077 NORTHERN BOULEVARD, ROSLYN, NY, 11576, US

(73) Assignee: Hella KGaA Hueck & Co.

(21) Appl. No.: 11/047,157

(22) Filed: Jan. 31, 2005

(30) Foreign Application Priority Data
Feb. 20, 2004 (DE) 10 2004 008 269.3

(51) Int. Cl. H01J 40/14

(52) U.S. Cl. 250/226; 250/216

(57) ABSTRACT

A sensor arrangement for determining brightness, comprising a photosensor and a reflector. The photosensor and the reflector are positioned such that light reflected by the reflector reaches the photosensor; and the reflector is designed such that a visible fraction of the ambient light is reflected, and an infrared fraction of the ambient light is transmitted. In this way, a sensor arrangement is created which is modeled on the perception of the human eye and which is comparatively easy and economical to produce.

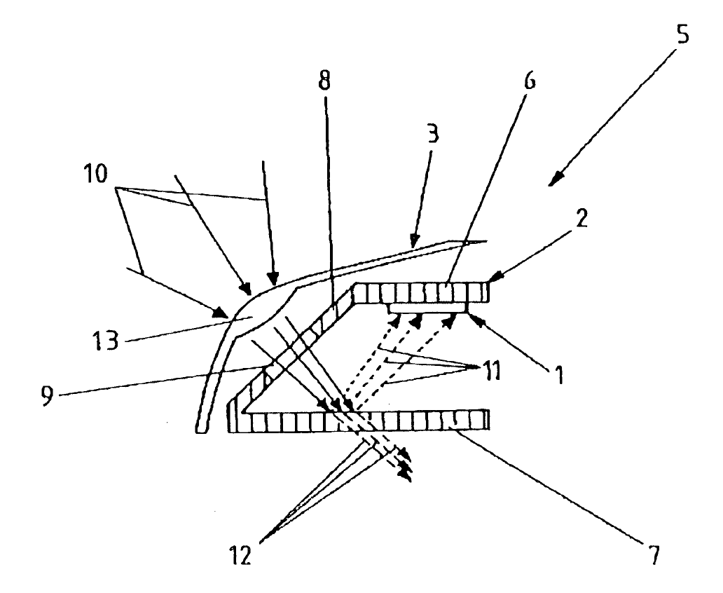

### BACKGROUND OF THE INVENTION

1. Field of the Invention

The invention relates to a sensor arrangement for determining brightness with a photosensor. In particular, the invention relates to a sensor arrangement of a spectral sensitivity which simulates that of the human eye.

2. The Prior Art

Sensor arrangements that make it possible to measure the brightness of ambient light in a way that is proportional to human perception are, for example, used in automatic systems for controlling the driving lights in motor vehicles. In this context, for example, U.S. Pat. No. 5,235,178 proposes the use of a sensor arrangement with a photosensor and a diffuser arranged in front of the photosensor. By means of the particular spectral sensitivity of the photosensor and the diffuser, a sensitivity is achieved which simulates that of the human eye. Similarly, in U.S. Pat. No. 5,036,437, a sensor arrangement is proposed in which a filter is added to a photosensor, which filter filters out parts of the light spectrum in order to achieve a spectral sensitivity which matches that of the human eye.

In Patent Nos. EP 0 876 264 B1, DE 197 40 928 A1, and U.S. Pat. No. 6,396,040 B1, sensor arrangements are proposed in which several sensors are used and their signals are evaluated together such that, as a result, a particular spectral sensitivity is achieved.

### SUMMARY OF THE INVENTION

It is an object of the present invention to provide a sensor arrangement of the type mentioned above, which is of a particularly simple design and is simple to produce.

This object is met by a sensor arrangement for determining brightness comprising a photosensor and a reflector, wherein the photosensor and the reflector are positioned such that light reflected by the reflector reaches the photosensor. The reflector is designed such that a visible fraction of ambient light is reflected, and another fraction of the ambient light, preferably an infrared fraction, is transmitted.

In this way, a particularly simple option and a particularly simple design of a sensor arrangement is created, which sensor arrangement makes it possible to measure the brightness of the ambient light, in a way that is proportional to that of the human eye.

Preferably, an economical silicon photosensor is used in the sensor arrangement according to the invention. Its spectral sensitivity, in particular in the infrared range, far exceeds the spectral sensitivity of the human eye. The sensor arrangement according to the invention makes it possible to use such a silicon photosensor. To this effect, the reflector is preferably made from a plastic material. There are a multitude of materials, in particular plastic materials, which reflect visible light and let the infrared fraction of the light spectrum pass through almost without hindrance, in other words this light path is transmitted. To this effect, the sensor arrangement comprises a selective reflector which does not reflect the invisible infrared fraction, so that the invisible infrared fraction does not contribute to the output signal of the photosensor.

Preferably, the sensor arrangement comprises a component carrier with an aperture. Through this aperture, light can enter the component carrier. To this effect, the reflector is preferably arranged opposite the aperture provided in the component carrier. In this arrangement, the photosensor is preferably arranged adjacent to the aperture provided in the component carrier. The photosensor and the reflector are thus positioned on opposite sides of the component carrier. Light which enters the component carrier through the aperture is reflected on the opposite side by the reflector and is projected onto the photosensor. In this way, the sensor arrangement can be designed in a very small geometric arrangement which is simple to construct. The reflector can also be arranged as an independent component in the component carrier. However, preferably a surface of the component carrier acts as the reflector. In particular, it is advantageous if the entire component carrier is made from a plastic material which has the desired reflector characteristics.

The reflector can be of a flat design; however, it is preferred if the reflector comprises a particular formed surface, in particular a convex surface design, so that the directional characteristic of the sensor is influenced. In another preferred embodiment, the component carrier is a closed housing, so that no further components are needed.

In an alternative preferred embodiment of the invention, a cover is provided above the component carrier. Preferably, this cover is made of plastic. Furthermore, at least one optical element is preferably integrated in the cover so as to be able to influence the directional characteristic of the entire sensor arrangement in a targeted way. As an alternative, the cover can also be designed so that its wall thickness is constant.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

The sole FIGURE in the drawing shows a diagrammatic cross-sectional view of the sensor arrangement according to the invention.

### DETAILED DESCRIPTION OF THE PREFERRED EMBODIMENT

Overall, the sensor arrangement is designated 5. The sensor arrangement comprises a carrier element 2 which comprises two opposite sides 6 and 7. Associated with side 6 is a slightly angled side 8 in which an aperture 9 is provided. Through the aperture 9, light shines in onto side 7 of carrier element 2 on which a reflector is arranged, or which side, as is the case in the embodiment shown, is entirely designed as a reflector. On side 6, which is opposite side 7, a sensor element 1 is arranged, which in the embodiment shown is a silicon photosensor. Carrier element 2 is built in one piece from one material. Ambient light radiation 10 entering through aperture 9 is reflected by the reflector, and a reflected visible fraction of ambient light radiation 11 is reflected onto sensor element 1. A transmitted infrared fraction of ambient light radiation 12 passes through the reflector in the embodiment shown through side 7 of carrier element 2. Above carrier element 2, a cover 3 is arranged which, in a region 13 which is associated with aperture 9, is a geometrical optical element, such as a focusing lens, so that a greater fraction of the ambient radiation 10 is directed into aperture 9 of carrier element 2 in a concentrated way.

Accordingly, while only a few embodiments of the present invention have been shown and described, it is obvious that many changes and modifications may be made thereunto without departing from the spirit and scope of the invention.

1. A sensor arrangement for determining brightness comprising:
a photosensor and a reflector, wherein the photosensor and the reflector are positioned such that light reflected by the reflector reaches the photosensor; and wherein the reflector is designed such that a visible fraction of ambient light is reflected, and another fraction of the ambient light is transmitted.

2. The sensor arrangement according to claim 1, wherein the photosensor is a silicon photosensor.

3. The sensor arrangement according to claim 1, wherein the reflector is made from a plastic material.

4. The sensor arrangement according to claim 1, wherein the sensor arrangement comprises a component carrier with an aperture.

5. The sensor arrangement according to claim 4, wherein the reflector is arranged opposite the aperture provided in the component carrier.

6. The sensor arrangement according to claim 4, wherein the photosensor is arranged adjacent to the aperture provided in the component carrier.

7. The sensor arrangement according to claim 4, wherein the reflector comprises a surface of the component carrier.

8. The component carrier according to claim 1, wherein a surface of the reflector is convex.

9. The sensor arrangement according to claim 4, wherein the component carrier is a closed housing.

10. The sensor arrangement according to claim 4, wherein a cover is provided above the component carrier.

11. The sensor arrangement according to claim 10, wherein the cover comprises an optical element.

12. The sensor arrangement according to claim 1, wherein the fraction of ambient light that is transmitted is infrared light.
